(19) United States
(12) Patent Application Publication
(10) Pub. No.: US 2022/0286060 A1
(43) Pub. Date: Sep. 8, 2022

(54) AIR CONDITIONER

(71) Applicant: Mitsubishi Electric Corporation, Tokyo (JP)

(72) Inventors: Keisuke UEMURA, Tokyo (JP); Kazunori HATAKEYAMA, Tokyo (JP); Koichi ARISAWA, Tokyo (JP)

(21) Appl. No.: 17/634,356

(22) PCT Filed: Aug. 30, 2019
(86) PCT No.: PCT/JP2019/034299

§ 371 Date: Feb. 10, 2022

(51) Int. Cl. H02M 7/217; H02M 1/00; F24F 11/30

(52) U.S. Cl. CPC H02M 7/217; H02M 1/0048; F24F 11/30; F24F 2140/20

(57) ABSTRACT

An air conditioner has a power conversion device including: a reactor having a first end and a second end, the first end being connected to an AC power supply; a rectifier circuit that is connected to the second end of the reactor and includes a diode and at least one or more switching elements, the rectifier circuit converting an AC voltage outputted from the AC power supply into a DC voltage; and a detection unit detecting a physical quantity indicating an operation state of the rectifier circuit. Switching is made between control for a current from the AC power supply to be applied to the diode or control for the current to be applied to the switching element in accordance with an operating mode of the air conditioner.

### CROSS REFERENCE TO RELATED APPLICATION

This application is a U.S. National Stage Application of International Patent No. PCT/JP2019/034299 filed on Aug. 30, 2019, the disclosure of which is incorporated herein by reference.

### TECHNICAL FIELD

The present invention relates to an air conditioner including a power conversion device that converts AC power into DC power.

### BACKGROUND

In the conventional art, there has been a power conversion device that converts supplied AC power into DC power to output the DC power, using a bridge circuit composed of diodes. In recent years, another type power conversion device has been developed which uses what is called a bridgeless circuit in which switching elements are connected in parallel with diodes. A power conversion device which uses a bridgeless circuit can perform control for boosting the voltage of AC power, power factor improvement control, synchronous rectification control for rectifying AC power, and the like based on operations of turning on and off the switching elements.

Patent Literature 1 discloses a technique for a power conversion device to perform synchronous rectification control, voltage boost control, power factor improvement control, and the like using a bridgeless circuit. The power conversion device described in Patent Literature 1 performs various operations by performing on/off control on the switching elements according to the magnitude of the load and switching between control modes, specifically, among diode rectification control, synchronous rectification control, partial switching control, and high-speed switching control.

### PATENT LITERATURE

Patent Literature 1: Japanese Patent Application Laid-open No. 2018-7326

As the switching elements of a bridgeless circuit, metal-oxide-semiconductor field-effect transistors (MOSFETs) are generally used. The characteristics of the diodes and MOSFETs used in the bridgeless circuit vary depending on the temperature. Specifically, a forward voltage drop of the diode decreases as the temperature increases. The on-resistance of the MOSFET increases as the temperature increases.

When the power conversion device described in Patent Literature 1 performs high-speed switching control and synchronous rectification control under a high load condition, the amount of heat generation in the MOSFETs increases. For this reason, the power conversion device described in Patent Literature 1 has been problematic in that a vicious cycle is caused thereby increasing the ambient temperature due to the heat generation of the MOSFETs, increasing the on-resistance thereof and so further increasing the amount of heat generation, so that efficiency may be down with leading to thermal runaway. A possible way to deal with this problem is to select the diode rectification control or the synchronous rectification control according to the temperature, but this way requires a dedicated temperature sensor, thereby a new problem being caused in that the number of components is increased thereby leading to increase in size and cost of the device.

### SUMMARY

The present invention has been made in view of the above circumstances, and an object thereof is to provide an air conditioner capable of realizing highly efficient operation while preventing a device from increasing in size and thermal runaway from being caused.

In order to solve the above-mentioned problems and achieve the object, the present invention provides an air conditioner including a power conversion device, the power conversion device comprising: a reactor having a first end and a second end, the first end being connected to an AC power supply; a rectifier circuit that is connected to the second end of the reactor and includes a diode and at least one or more switching elements, the rectifier circuit converting an AC voltage outputted from the AC power supply into a DC voltage; and a detection unit detecting a physical quantity indicating an operation state of the rectifier circuit, wherein the air conditioner makes switching between control for a current from the AC power supply to be applied to the diode and control for the current to be applied to the switching element in accordance with an operating mode of the air conditioner.

The air conditioner according to the present invention can achieve an advantageous effect that is can realize highly efficient operation while preventing a device from increasing in size and thermal runaway from being caused.

### BRIEF DESCRIPTION OF DRAWINGS

FIG. 1 is a diagram illustrating an exemplary configuration of an air conditioner including a power conversion device according to a first embodiment.

FIG. 2 is a diagram illustrating another example of a rectifier circuit provided in the power conversion device according to the first embodiment.

FIG. 3 is a schematic cross-sectional view illustrating an outline structure of a MOSFET used to constitute a switching element according to the first embodiment.

FIG. 4 is a diagram illustrating paths through which an electric current passes in the power conversion device according to the first embodiment.

FIG. 5 is a chart illustrating timings at which a control unit turns on the switching elements in the power conversion device according to the first embodiment.

FIG. 6 is a diagram illustrating an example of an AC current control method for the power conversion device according to the first embodiment, in which a power supply short-circuit mode and a load power supply mode are used.

FIG. 7 is a diagram illustrating another example of paths through which an electric current passes in the power conversion device according to the first embodiment.

FIG. 8 is a graph illustrating temperature characteristics of a MOSFET that is a switching element used in the rectifier circuit of the power conversion device according to the first embodiment.

FIG. 9 is a graph illustrating temperature characteristics of a commonly used diode such as a parasitic diode used in the rectifier circuit of the power conversion device according to the first embodiment.

FIG. 10 is a diagram illustrating an example of the location of a substrate equipped with the power conversion device and installed in an outdoor unit of the air conditioner according to the first embodiment.

FIG. 11 is a flowchart illustrating a control operation performed by the control unit of the power conversion device according to the first embodiment.

FIG. 12 is a diagram illustrating an exemplary hardware configuration for implementing the control unit provided in the power conversion device according to the first embodiment.

FIG. 13 is a flowchart illustrating a control operation performed by a control unit of a power conversion device according to a second embodiment.

FIG. 14 is a diagram illustrating an exemplary configuration of a motor drive apparatus according to a third embodiment.

FIG. 15 is a diagram illustrating an exemplary configuration of an air conditioner according to a fourth embodiment.

### DETAILED DESCRIPTION

Hereinafter, an air conditioner according to embodiments of the present invention will be described in detail with reference to the drawings. It is noted that the present invention is not necessarily limited by these embodiments.

### First Embodiment

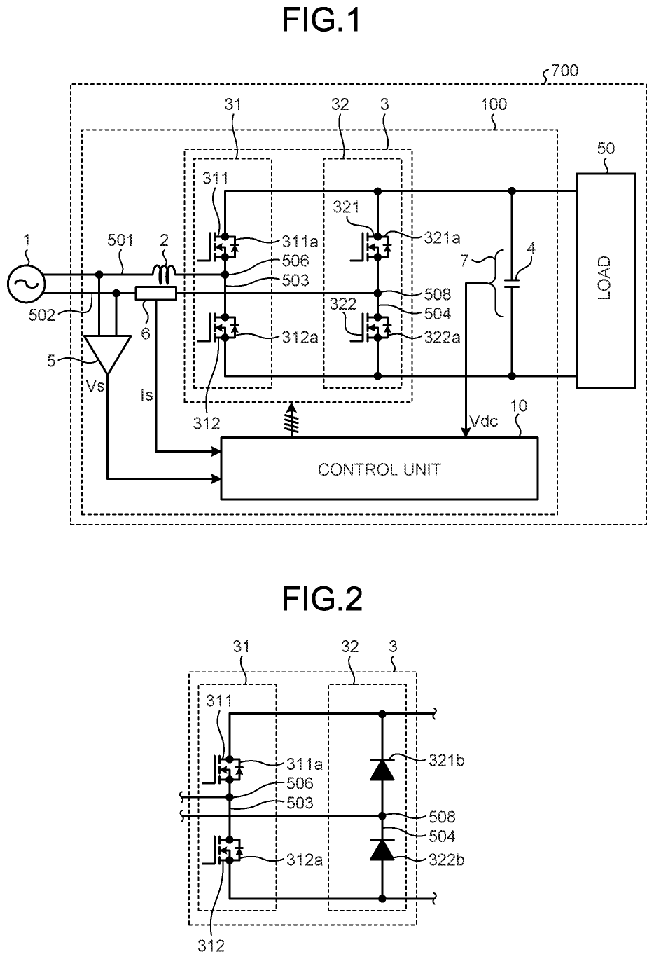

FIG. 1 is a diagram illustrating an exemplary configuration of an air conditioner 700 including a power conversion device 100 according to the first embodiment of the present invention. The air conditioner 700 includes the power conversion device 100. The power conversion device 100 is a power supply device having an AC-DC conversion function of converting AC power supplied from an AC power supply 1 into DC power using a rectifier circuit 3 and applying the DC power to a load 50. As illustrated in FIG. 1, the power conversion device 100 includes a reactor 2, the rectifier circuit 3, a smoothing capacitor 4, a power supply voltage detection unit 5, a power supply current detection unit 6, a bus voltage detection unit 7, and a control unit 10. The reactor 2 has a first end and a second end, and the first end is connected to the AC power supply 1.

The rectifier circuit 3 is a circuit including two arms connected in parallel, each arm having two switching elements connected in series, each switching element being connected in parallel with a diode. Specifically, the rectifier circuit 3 includes a first arm 31 that is a first circuit and a second arm 32 that is a second circuit. The first arm 31 includes a switching element 311 and a switching element 312 which are connected in series. A parasitic diode 311a is formed in the switching element 311. The parasitic diode 311a is connected in parallel between a drain and a source of the switching element 311. A parasitic diode 312a is formed in the switching element 312. The parasitic diode 312a is connected in parallel between a drain and a source of the switching element 312. Each of the parasitic diodes 311a and 312a is a diode that is used as a freewheel diode.

The second arm 32 includes a switching element 321 and a switching element 322 which are connected in series. The second arm 32 is connected in parallel with the first arm 31. A parasitic diode 321a is formed in the switching element 321. The parasitic diode 321a is connected in parallel between a drain and a source of the switching element 321. A parasitic diode 322a is formed in the switching element 322. The parasitic diode 322a is connected in parallel between a drain and a source of the switching element 322. Each of the parasitic diodes 321a and 322a is a diode that is used as a freewheel diode.

More specifically, the power conversion device 100 includes a first wiring line 501 and a second wiring line 502 each connected to the AC power supply 1, and the reactor 2 located on the first wiring line 501. The first arm 31 includes the switching element 311 that is a first switching element, the switching element 312 that is a second switching element, and a third wiring line 503 having a first connection point 506. The switching element 311 and the switching element 312 are connected in series by the third wiring line 503. The first wiring line 501 is connected to the first connection point 506. The first connection point 506 is connected to the AC power supply 1 via the first wiring line 501 and the reactor 2. The first connection point 506 is connected to the second end of the reactor 2.

The second arm 32 includes the switching element 321 that is a third switching element, the switching element 322 that is a fourth switching element, and a fourth wiring line 504 having a second connection point 508. The switching element 321 and the switching element 322 are connected in series by the fourth wiring line 504. The second wiring line 502 is connected to the second connection point 508. The second connection point 508 is connected to the AC power supply 1 via the second wiring line 502. Note that the rectifier circuit 3 only needs to include at least one or more switching elements such that an AC voltage outputted from the AC power supply 1 can be converted into a DC voltage.

The smoothing capacitor 4 is a capacitor connected in parallel with the rectifier circuit 3, more specifically the second arm 32. In the rectifier circuit 3, one end of the switching element 311 is connected to a positive side of the smoothing capacitor 4, the other end of the switching element 311 is connected to one end of the switching element 312, and the other end of the switching element 312 is connected to a negative side of the smoothing capacitor 4.

The switching elements 311, 312, 321, and 322 are configured by MOSFETs. As the switching elements 311, 312, 321, and 322, MOSFETs each formed of a wide bandgap (WBG) semiconductor such as gallium nitride (GaN), silicon carbide (SiC), diamond, or aluminum nitride can be used. The use of WBG semiconductors for the switching elements 311, 312, 321, and 322 raises voltage endurance and allowable electric current density, so that the module can be downsized. A heat dissipation fin of a heat dissipation unit can also be reduced in size since the WBG semiconductors have high heat resistance.

The control unit 10 generates drive signals for operating the switching elements 311, 312, 321, and 322 of the rectifier circuit 3 based on signals that are outputted from the power supply voltage detection unit 5, the power supply current detection unit 6, and the bus voltage detection unit 7, respectively. The power supply voltage detection unit 5 is a voltage detection unit that detects a power supply voltage Vs that corresponds to a voltage value of an output voltage from the AC power supply 1 and outputs an electric signal indicating the detection result to the control unit 10. The power supply current detection unit 6 is a current detection unit that detects a power supply electric current Is that corresponds to a current value of an electric current outputted from the AC power supply 1 and outputs an electric signal indicating the detection result to the control unit 10. The power supply current Is is the current value of an electric current flowing between the AC power supply 1 and the rectifier circuit 3. Note that the power supply current detection unit 6 only needs to be able to detect an electric current flowing in the rectifier circuit 3, and therefore may be installed at a position different from that in the example of FIG. 1, e.g. between the rectifier circuit 3 and the smoothing capacitor 4 or between the smoothing capacitor 4 and the load 50. The bus voltage detection unit 7 is a voltage detection unit configured to detect a bus voltage Vdc and output an electric signal indicating the detection result to the control unit 10. The bus voltage Vdc is a voltage obtained by smoothing an output voltage of the rectifier circuit 3 using the smoothing capacitor 4. In the following description, the power supply voltage detection unit 5, the power supply current detection unit 6, and the bus voltage detection unit 7 may be simply referred to as detection units or a detection unit case by case. In addition, the power supply voltage Vs detected by the power supply voltage detection unit 5, the power supply current Is detected by the power supply current detection unit 6, and the bus voltage Vdc detected by the bus voltage detection unit 7 may be sometimes referred to as physical quantity or quantities indicating an operation state of the rectifier circuit 3. The control unit 10 performs on/off control on the switching elements 311, 312, 321, and 322 according to the power supply voltage Vs, the power supply current Is, and the bus voltage Vdc. Note that the control unit 10 may perform on/off control on the switching elements 311, 312, 321, and 322 using at least one of the power supply voltage Vs, the power supply current Is, and the bus voltage Vdc.

Next, a basic operation of the power conversion device 100 according to the first embodiment will be described. Hereinafter, the switching elements 311 and 321 connected to the positive side of the AC power supply 1, that is, a positive electrode terminal of the AC power supply 1, may be referred to as upper switching elements case by case. Similarly, the switching elements 312 and 322 connected to the negative side of the AC power supply 1, that is, a negative electrode terminal of the AC power supply 1, may be referred to as lower switching elements case by case.

In the first arm 31, the upper switching element and the lower switching element operate complementarily. That is, when one of the upper switching element and the lower switching element is on, the other is off. The switching elements 311 and 312 constituting the first arm 31 are driven by PWM signals that are drive signals generated by the control unit 10 as described later. The on or off operation of the switching elements 311 and 312 that is performed in accordance with the PWM signals is hereinafter also referred to as switching operation. In order to prevent the smoothing capacitor 4 from being short-circuited through the AC power supply 1 and the reactor 2, the switching element 311 and the switching element 312 are both turned off when the absolute value of the power supply current Is outputted from the AC power supply 1 is equal to or less than a current threshold. A short circuit of the smoothing capacitor 4 is hereinafter referred to as a capacitor short circuit. A capacitor short circuit is a state in which energy stored in the smoothing capacitor 4 is released and an electric current is regenerated back to the AC power supply 1.

The switching elements 321 and 322 constituting the second arm 32 are turned on or off by the drive signals generated by the control unit 10. Basically, the switching elements 321 and 322 are put in an on or off state in accordance with a power supply voltage polarity that is a polarity of the voltage outputted from the AC power supply 1. More specifically, when the power supply voltage polarity is positive, the switching element 322 is on and the switching element 321 is off, but when the power supply voltage polarity is negative, the switching element 321 is on and the switching element 322 is off. Note that in FIG. 1, an arrow from the control unit 10 toward the rectifier circuit 3 represents drive signals for on/off control on the switching elements 321 and 322 and the previously-described PWM signals for on/off control on the switching elements 311 and 312.

In the power conversion device 100 illustrated in FIG. 1, only the parasitic diodes 311a, 312a, 321a, and 322a are depicted for the switching elements 311, 312, 321, and 322, but this depiction is merely an example. Diodes such as rectifier diodes or Schottky barrier diodes may be separately connected in parallel with the switching elements 311, 312, 321, and 322. In addition, the power conversion device 100 illustrated in FIG. 1 has a configuration in which the rectifier circuit 3 includes the four switching elements 311, 312, 321, and 322, but two switching elements may be removed from one arm so that the arm consists of two diodes. FIG. 2 is a diagram illustrating another example of the rectifier circuit 3 provided in the power conversion device 100 according to the first embodiment. FIG. 2 depicts an example in which the second arm 32 is composed of two diodes 321b and 322b. In this manner, the rectifier circuit 3 may have a circuit configuration in which the switching elements 311 and 312 and the diodes 321b and 322b are used in combination. The circuit configuration illustrated in FIG. 2 can also achieve an advantageous effect of the present embodiment. However, in the case of the configuration of the rectifier circuit 3 illustrated in FIG. 2, the power conversion device 100 performs on/off control on the switching elements 311 and 312. The power conversion device 100 illustrated in FIG. 1 is described by way of example in the following part.

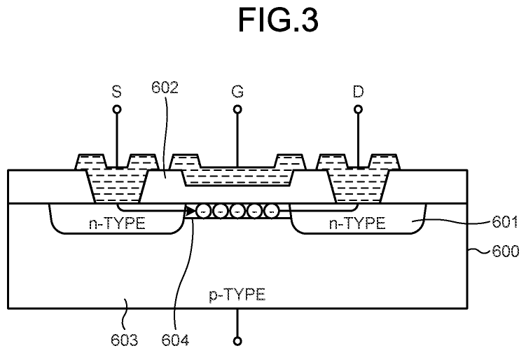

Next, description is given for the relationship between the states of the switching elements 311, 312, 321, and 322 in the first embodiment and paths through which electric currents flow in the power conversion device 100 according to the first embodiment. Before this description, the structure of a MOSFET will be described with reference to FIG. 3.

FIG. 3 is a schematic cross-sectional view illustrating an outline structure of a MOSFET used to constitute each of the switching elements 311, 312, 321, and 322 according to the first embodiment. In FIG. 3, an n-type MOSFET is illustrated. In the case of the n-type MOSFET, a p-type semiconductor substrate 600 is used as illustrated in FIG. 3. A source electrode S, a drain electrode D, and a gate electrode G are formed on the semiconductor substrate 600. High-concentration impurity is ion-implanted into a region having contact with the source electrode S and the drain electrode D to form n-type regions 601. On the semiconductor substrate 600, an oxide insulating film 602 is formed between a portion without the n-type regions 601 and the gate electrode G. That is, the oxide insulating film 602 is interposed between the gate electrode G and a p-type region 603 of the semiconductor substrate 600.

When a positive voltage is applied to the gate electrode G, electrons are attracted to an interface between the p-type region 603 of the semiconductor substrate 600 and the oxide insulating film 602, and the interface is negatively charged. In a portion where electrons gather, the density of electrons becomes greater than the hole density. Therefore, this portion becomes n-type. This n-type portion serves as an electric current path, which is called a channel 604. The channel 604 is an n-type channel in the example of FIG. 3. When the MOSFET is controlled to be on, the current flowing through the channel 604 is larger than through the parasitic diode formed in the p-type region 603.

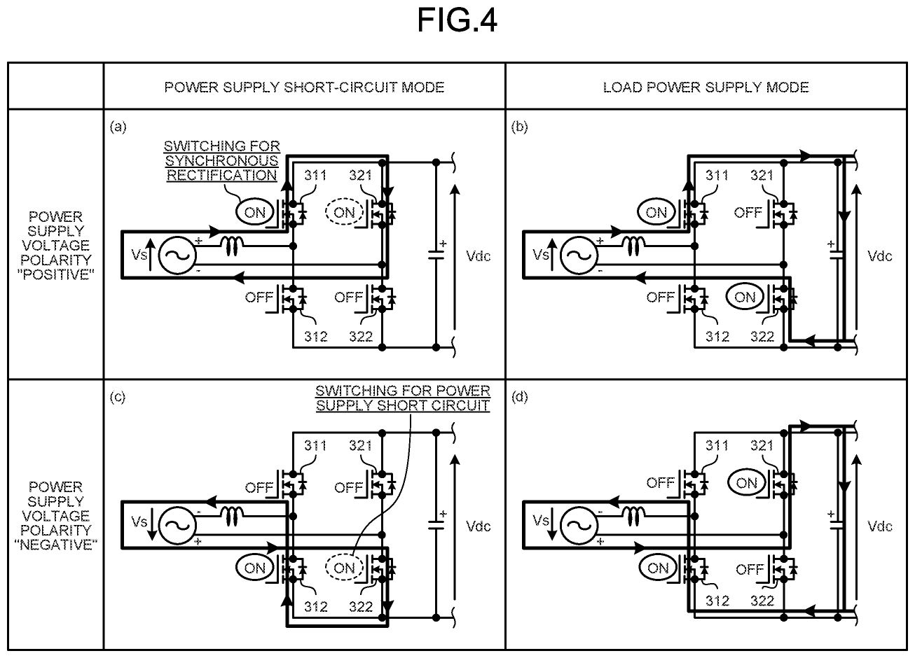

FIG. 4 is a diagram illustrating paths through which a current passes in the power conversion device 100 according to the first embodiment. In FIG. 4, only the switching elements 311, 312, 321, and 322 are denoted by their respective reference signs for the sake of simplicity. In FIG. 4, a switching element that is in an on state under synchronous rectification control is represented by a solid circle, and a switching element that is in an on state under power supply short circuit is represented by a dotted circle.

(a) of FIG. 4 is a diagram illustrating a path through which a current flows in the power conversion device 100 according to the first embodiment for the case that the absolute value of the power supply current Is is larger than the current threshold and the power supply voltage polarity is positive. In the part (a) of FIG. 4, the power supply voltage polarity is positive, the switching element 311 and the switching element 321 are on, and the switching element 312 and the switching element 322 are off. The switching element 311 is on for the synchronous rectification control, and the switching element 321 is on for the power supply short circuit. The part (a) of FIG. 4 depicts the state of a power supply short-circuit mode when the power supply voltage polarity is positive. In this state, the current flows through the AC power supply 1, the reactor 2, the switching element 311, the switching element 321, and the AC power supply 1 in this order, and a power supply short-circuit path that does not include the smoothing capacitor 4 is formed. In this manner, in the first embodiment, the current does not flow through the parasitic diode 311a and the parasitic diode 321a but flows through the respective channels of the switching element 311 and the switching element 321 thereby to form the power supply short-circuit path.

(b) of FIG. 4 is a diagram illustrating a path through which a current flows in the power conversion device 100 according to the first embodiment for the case that the absolute value of the power supply current Is is larger than the current threshold and the power supply voltage polarity is positive. In the part (b) of FIG. 4, the power supply voltage polarity is positive, the switching element 311 and the switching element 322 are on, and the switching element 312 and the switching element 321 are off. The switching element 311 and the switching element 322 are on for the synchronous rectification control. The part (b) of FIG. 4 depicts the state of a load power supply mode when the power supply voltage polarity is positive. In this state, the current flows through the AC power supply 1, the reactor 2, the switching element 311, the smoothing capacitor 4, the switching element 322, and the AC power supply 1 in this order. In this manner, in the first embodiment, the current does not flow through the parasitic diode 311a and the parasitic diode 322a but flows through the respective channels of the switching element 311 and the switching element 322 thereby to perform the synchronous rectification control.

(c) of FIG. 4 is a diagram illustrating a path through which a current flows in the power conversion device 100 according to the first embodiment for the case that the absolute value of the power supply current Is is larger than the current threshold and the power supply voltage polarity is negative. In the part (c) of FIG. 4, the power supply voltage polarity is negative, the switching element 312 and the switching element 322 are on, and the switching element 311 and the switching element 321 are off. The switching element 312 is on for the synchronous rectification control, and the switching element 322 is on for the power supply short circuit. The part (c) of FIG. 4 depicts the state of a power supply short-circuit mode when the power supply voltage polarity is negative. In this state, the current flows through the AC power supply 1, the switching element 322, the switching element 312, the reactor 2, and the AC power supply 1 in this order, and a power supply short-circuit path that does not include the smoothing capacitor 4 is formed. In this manner, in the first embodiment, the current does not flow through the parasitic diode 322a and the parasitic diode 312a but flows through the respective channels of the switching element 322 and the switching element 312 thereby to form the power supply short-circuit path.

(d) of FIG. 4 is a diagram illustrating a path through which a current flows in the power conversion device 100 according to the first embodiment for the case that the absolute value of the power supply current Is is larger than the current threshold and the power supply voltage polarity is negative. In the part (d) of FIG. 4, the power supply voltage polarity is negative, the switching element 312 and the switching element 321 are on, and the switching element 311 and the switching element 322 are off. The switching element 312 and the switching element 321 are on for the synchronous rectification control. The part (d) of FIG. 4 depicts the state of a load power supply mode when the power supply voltage polarity is negative. In this state, the current flows through the AC power supply 1, the switching element 321, the smoothing capacitor 4, the switching element 312, the reactor 2, and the AC power supply 1 in this order. In this manner, in the first embodiment, the current does not flow through the parasitic diode 321a and the parasitic diode 312a but flows through the respective channels of the switching element 321 and the switching element 312 thereby to perform the synchronous rectification control.

The control unit 10 can control the values of the power supply current Is and the bus voltage Vdc by controlling the switching of the current paths described above. Specifically, the control unit 10 performs power factor improvement control and voltage boost control by performing on/off control on the switching elements 311, 312, 321, and 322 so as to form a current path that makes a power supply short circuit via the reactor 2. The power conversion device 100 continuously switches between the load power supply mode illustrated in the part (b) of FIG. 4 and the power supply short-circuit mode illustrated in the part (a) of FIG. 4 when the power supply voltage polarity is positive, and continuously switches between the load power supply mode illustrated in the part (d) of FIG. 4 and the power supply short-circuit mode illustrated in the part (c) of FIG. 4 when the power supply voltage polarity is negative, thereby implementing operations such as increasing the bus voltage Vdc and the synchronous rectification control of the power supply current Is. More specifically, the control unit 10 performs on/off control on the switching elements 311, 312, 321, and 322 by making the switching frequency of the switching elements 311 and 312 that perform the PWM-based switching operation higher than the switching frequency of the switching elements 321 and 322 that perform the switching operation according to the polarity of the power supply voltage Vs. In the following description, the switching elements 311, 312, 321, and 322 may be collectively simply referred to as switching elements or element for a case without distinction of them. Similarly, the parasitic diodes 311a, 312a, 321a, and 322a may be collectively simply referred to as parasitic diodes or diode for a case without distinction of them.

Note that the switching patterns of the switching elements are illustrated in FIG. 4 by way of example, and the power conversion device 100 can use current paths other than the switching patterns of the switching elements illustrated in FIG. 4. The power conversion device 100 can exert an advantageous effect of the present embodiment in any switching pattern.

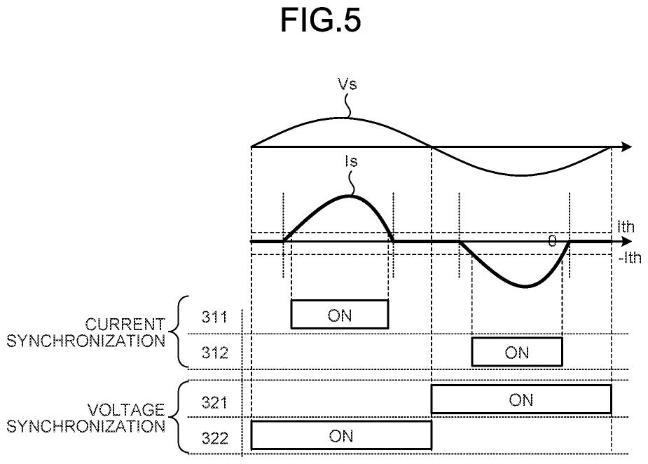

Next, timings at which the control unit 10 turns on and off the switching elements will be described. FIG. 5 is a chart illustrating timings at which the control unit 10 turns on the switching elements in the power conversion device 100 according to the first embodiment. In FIG. 5, the horizontal axis represents time. In FIG. 5, “Vs” represents the power supply voltage Vs detected by the power supply voltage detection unit 5, and “Is” represents the power supply current Is detected by the power supply current detection unit 6. FIG. 5 shows that the switching elements 311 and 312 are current-synchronous switching elements that are controlled to be on or off according to the polarity of the power supply current Is, and shows that the switching elements 321 and 322 are voltage-synchronous switching elements that are controlled to be on or off according to the polarity of the power supply voltage Vs. In FIG. 5, “Ith” represents the current threshold. Although FIG. 5 depicts one cycle of the AC power outputted from the AC power supply 1, it is assumed that the control unit 10 performs control similar to the control illustrated in FIG. 5 even in other cycles.

When the power supply voltage polarity is positive, the control unit 10 turns on the switching element 322 and turns off the switching element 321. When the power supply voltage polarity is negative, the control unit 10 turns on the switching element 321 and turns off the switching element 322. In FIG. 5, the timing at which the switching element 322 switches from on to off corresponds to the timing at which the switching element 321 switches from off to on, but these timings are not necessarily limited to this manner. The control unit 10 may provide a dead time in which both the switching elements 321 and 322 are off, between the timing at which the switching element 322 switches from on to off and the timing at which the switching element 321 switches from off to on. Similarly, the control unit 10 may provide a dead time in which both the switching elements 321 and 322 are off, between the timing at which the switching element 321 switches from on to off and the timing at which the switching element 322 switches from off to on.

When the power supply voltage polarity is positive, the control unit 10 turns on the switching element 311 in response to the absolute value of the power supply current Is becoming equal to or larger than the current threshold Ith. Thereafter, as the absolute value of the power supply current Is becomes smaller, the control unit 10 turns off the switching element 311 in response to the absolute value of the power supply current Is falling below the current threshold Ith. When the power supply voltage polarity is negative, the control unit 10 turns on the switching element 312 in response to the absolute value of the power supply current Is becoming equal to or larger than the current threshold Ith. Thereafter, as the absolute value of the power supply current Is becomes smaller, the control unit 10 turns off the switching element 312 in response to the absolute value of the power supply current Is falling below the current threshold Ith.

When the absolute value of the power supply current Is is equal to or smaller than the current threshold Ith, the control unit 10 performs control such that the upper switching elements, namely the switching element 311 and the switching element 321, are not simultaneously on, and performs control such that the lower switching elements, namely the switching element 312 and the switching element 322, are not simultaneously on. Consequently, the control unit 10 can prevent a capacitor short circuit in the power conversion device 100. The control unit 10 can enhance the efficiency of the power conversion device 100 by turning on and off the switching elements as illustrated in FIG. 5.

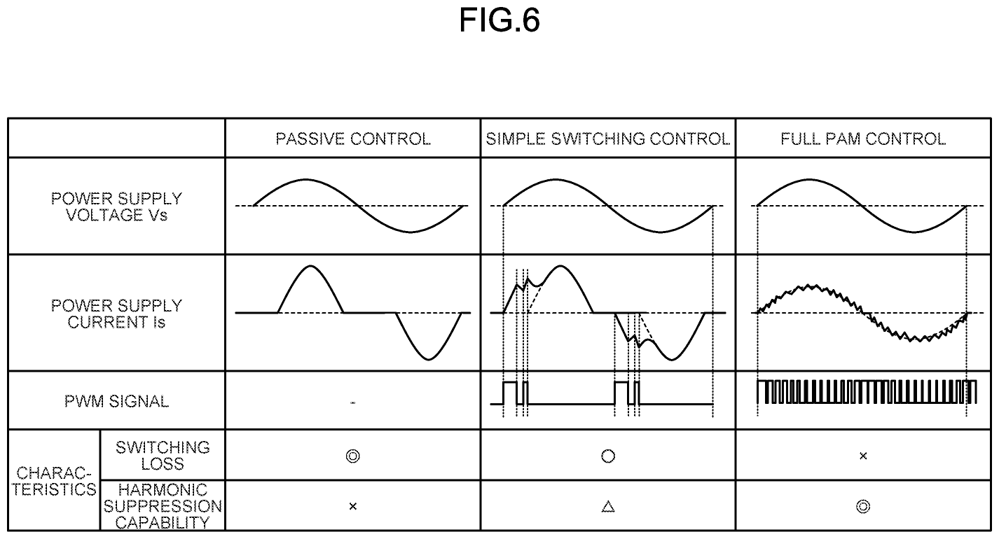

FIG. 6 is a diagram illustrating an example of an AC current control method for the power conversion device 100 according to the first embodiment, in which a power supply short-circuit mode and a load power supply mode are used. FIG. 6 depicts various AC current control methods for passive control, simple switching control, and full pulse amplitude modulation (PAM) control in which PAM control is continuously performed, and this depiction covers the waveform of the power supply voltage Vs, the waveform of the power supply current Is, the PWM signal for the switching element 321, and characteristics.

The passive control has the same state as that in the example of FIG. 5 described above. In the passive control, the control unit 10 does not use PWM signals for on/off control on each switching element. The passive control is characterized by its small loss associated with turning on/off the switching elements but also by poor harmonic suppression capability, compared with the other AC current control methods.

The simple switching control is a control mode in which the control unit 10 executes the power supply short-circuit mode once or several times during a half cycle of power supply. The simple switching control is advantageously characterized by infrequent switching, which achieves small switching loss. However, due to the infrequent switching, the simple switching control has difficulty in shaping the AC current waveform into a complete sinusoidal form, and thus has a low rate of power factor improvement.

The full PAM control is a control mode in which the control unit 10 continuously switches between the power supply short-circuit mode and the load power supply mode to make a switching frequency several kHz or more. The full PAM control is advantageously characterized by a high rate of improvement of the power factor owing to the continuous switching between the power supply short-circuit mode and the load power supply mode. However, the full PAM control has large switching loss due to the frequent switching. The simple switching control and the full PAM control have a common point that they can achieve a better power factor than the passive control.

In a case where the power conversion device 100 is installed in the air conditioner 700 as illustrated in FIG. 1, the air conditioner 700 requires a converter operation taking into consideration breaker limitation. In the air conditioner 700, the flow of alternating current increases as the load increases. The air conditioner 700 with a poor power factor causes an increase in the alternating current and thus cannot operate under large load conditions. Therefore, the power conversion device 100 installed in the air conditioner 700 performs the simple switching control, the full PAM control, or the like as described above.

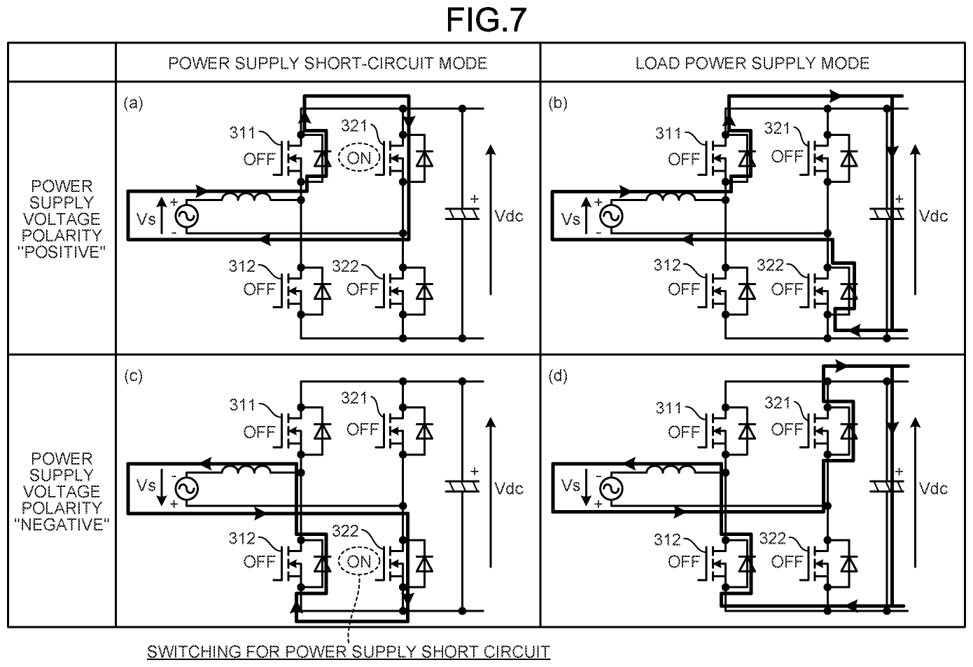

Next, the relationship between the power supply short-circuit and load power supply modes and the synchronous rectification control in the power conversion device 100 will be described. In the example of the power supply short-circuit mode and the load power supply mode illustrated in FIG. 4, as described above, the switching elements indicated by dotted circles are switching elements that are on to make a power supply short-circuit path, and the switching elements indicated by solid circles are switching elements that are on to perform the synchronous rectification control. The example of FIG. 4 is based on the assumption that the synchronous rectification control is performed in the power conversion device 100 simultaneously with the power supply short-circuit mode or the load power supply mode. However, in the power conversion device 100, it is also possible to perform control in combination with diode rectification control as illustrated in FIG. 7.

FIG. 7 is a diagram illustrating other examples of paths through which a current flows in the power conversion device 100 according to the first embodiment. In FIG. 7, among the switching elements illustrated in FIG. 4, all the switching elements indicated by solid circles are off. This is because the switching elements that are MOSFETs have current paths in which the parasitic diodes of the MOSFETs are used. As illustrated in FIG. 7, the control unit 10 can realize the power supply short-circuit mode and the load power supply mode even when all the switching elements other than the switching elements that perform switching for power supply short circuit are off. In this manner, the control unit 10 can cause the power conversion device 100 to perform a desired operation without necessarily performing the synchronous rectification control in the circuit configuration illustrated in FIG. 1. Although FIG. 7 depicts the switching patterns of the switching elements under the condition where the synchronous rectification control is completely stopped, the control unit 10 may perform control using the synchronous rectification control illustrated in FIG. 4 and the diode rectification control illustrated in FIG. 7 in combination.

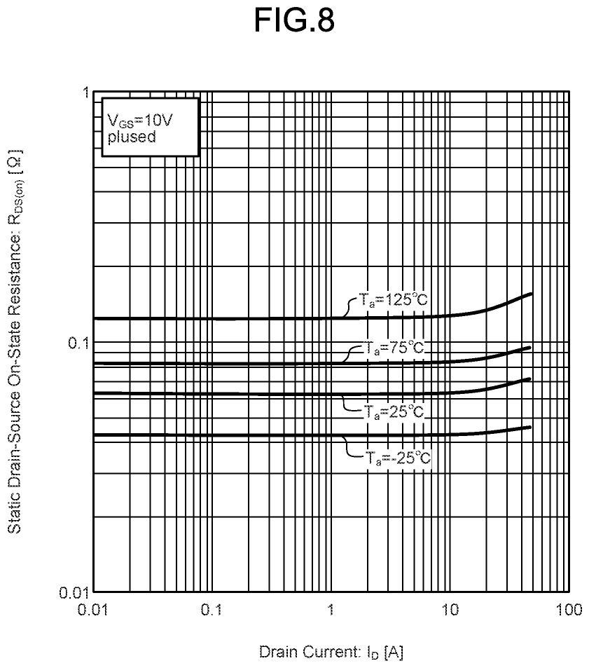

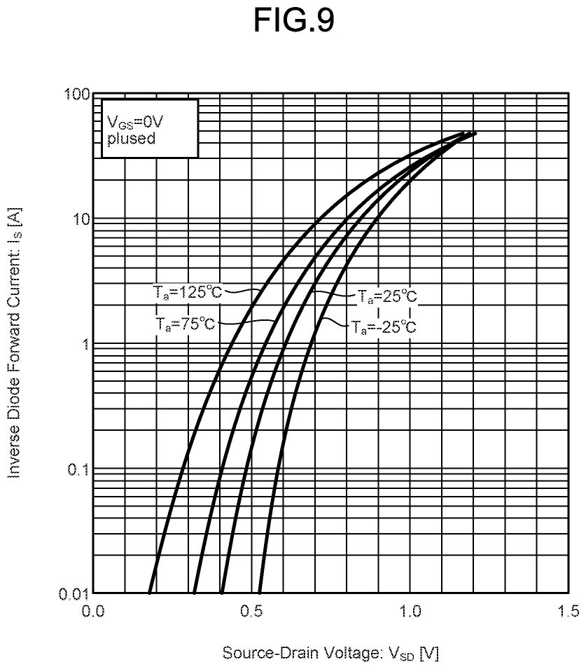

As described above, in general, diodes and MOSFETs have temperature characteristics that the voltage drop varies depending on the temperature. This also applies to the parasitic diodes 311a, 312a, 321a, and 322a and the switching elements 311, 312, 321, and 322 that are MOSFETs, all of which are provided in the rectifier circuit 3. FIG. 8 is a graph illustrating temperature characteristics of a MOSFET that is a switching element used in the rectifier circuit 3 of the power conversion device 100 according to the first embodiment. In FIG. 8, the horizontal axis represents the current, and the vertical axis represents the on-resistance. FIG. 8 depicts the differences in on-resistance of the MOSFET depending upon temperature, which shows that as the temperature increases, the on-resistance increases, that is, the drain-source voltage increases. FIG. 9 is a graph illustrating temperature characteristics of a general diode such as a parasitic diode used in the rectifier circuit 3 of the power conversion device 100 according to the first embodiment. In FIG. 9, the horizontal axis represents the forward voltage, and the vertical axis represents the current. FIG. 9 depicts the differences in forward voltage drop of the diode depending upon temperature, which shows that the forward voltage drop decreases as the temperature increases.

FIGS. 8 and 9 suggest that the power conversion device 100 can operate more efficiently with selecting the diode rectification control under conditions where the temperature of a semiconductor device becomes higher.

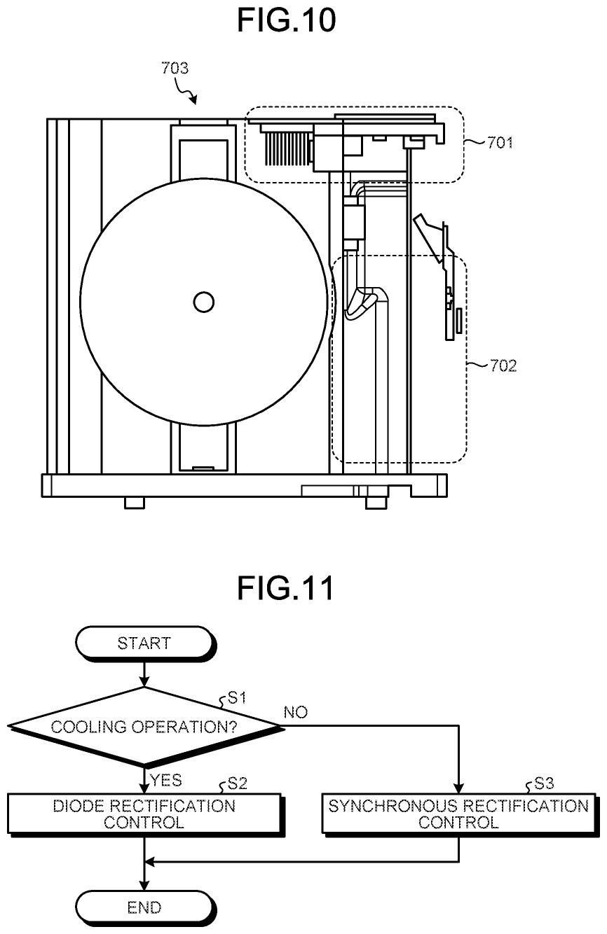

Here we consider a case where the power conversion device 100 is installed in the air conditioner 700, particularly in an outdoor unit thereof (not illustrated in FIG. 1). The air conditioner 700 is a device that performs a cooling operation and a heating operation. During the cooling operation, the ambient temperature of the outdoor unit is usually assumed to be higher than an average air temperature. Therefore, the ambient temperature of a substrate 701 mounted with the power conversion device 100, which is installed in the outdoor unit, also increases. In particular, when the substrate 701 equipped with the power conversion device 100 is installed in the outdoor unit, as illustrated in FIG. 10, the substrate 701 is often located on the upper side of the compressor, in the vicinity of the heat exchanger of the outdoor unit, or the like, and is likely to be affected by heat leakage from the compressor, the heat exchanger of the outdoor unit, or the like. FIG. 10 is a diagram illustrating an example of the location of the substrate 701 equipped with the power conversion device 100, the substrate 701 being installed in the outdoor unit 703 of the air conditioner 700 according to the first embodiment. FIG. 10 depicts an example in which the substrate 701 mounted with the power conversion device 100 is installed on the upper side of a machine chamber 702 including the compressor, the heat exchanger, and the like in the outdoor unit 703. During a cooling operation under high outside air temperature, a discharge temperature of the compressor tends to be higher than that during a heating operation, and even higher than the air temperature at the location of the outdoor unit 703. In addition, under conditions where the ambient temperature is very high, the temperature of the semiconductor elements is affected more dominantly by the ambient temperature than the temperature rise caused by loss in the elements.

In consideration of these temperature characteristics of MOSFETs and diodes, the control unit 10 selects the synchronous rectification control or the diode rectification control. Here, newly installing a temperature sensor for considering the temperature characteristics causes an increase in the number of components, thereby leading to an increase in cost. Therefore, when the air conditioner 700 is in a cooling operation, the control unit 10 determines that the ambient temperature of the power conversion device 100 is high, and chooses to perform the diode rectification control using the parasitic diodes 311a, 312a, 321a, and 322a in the rectifier circuit 3. Consequently, the control unit 10 can perform highly efficient operation as compared with the case of performing the synchronous rectification control using the switching elements 311, 312, 321, and 322 that are MOSFETs. During a cooling operation under high outside air temperature, in the power conversion device 100, the on-resistance of the switching elements 311, 312, 321, and 322 that are MOSFETs is large, thereby causing an increase in heat generation of the MOSFETs. In the power conversion device 100, as the heat generation of the MOSFETs increases, the on-resistance further increases, and in turn further the heat generation is further increased. On the other hand, the temperature characteristics of the diodes are opposite to those of the MOSFETs. Therefore, during a cooling operation under high outside air temperature, the power conversion device 100 chooses to perform the diode rectification control using the parasitic diodes 311a, 312a, 321a, and 322a in the rectifier circuit 3. In this manner, the control unit 10 can avoid the vicious cycle of increasing the heat generation of the MOSFETs, and can also realize high reliability.

Next, the operation of the control unit 10 during a heating operation will be described. A situation in the heating operation is opposite to that in the cooling operation, in which the ambient temperature of the outdoor unit 703 of the air conditioner 700 is low. Therefore, the control unit 10 chooses to perform the synchronous rectification control using the switching elements 311, 312, 321, and 322 in consideration of the fact that the on-resistance of the switching elements 311, 312, 321, and 322 that are MOSFETs further decreases with dependence on temperature, based on the temperature characteristics illustrated in FIGS. 8 and 9. In this manner, the control unit 10 can perform highly efficient operation. Therefore, the control unit 10 selects the synchronous rectification control with use of the switching elements 311, 312, 321, and 322 when the air conditioner 700 is in a heating operation.

FIG. 11 is a flowchart illustrating a control operation performed by the control unit 10 of the power conversion device 100 according to the first embodiment. The control unit 10 determines whether or not the operating mode of the air conditioner 700 corresponds to a cooling operation (step S1). For example, the control unit 10 can identify the operating mode of the air conditioner 700 by acquiring information on an operating mode received from a user, from the air conditioner 700, but a manner of acquiring information on the operating mode is not limited to this example. When the operating mode of the air conditioner 700 corresponds to a cooling operation (step S1: Yes), the control unit 10 chooses to perform the diode rectification control with use of the parasitic diodes 311a, 312a, 321a, and 322a in the rectifier circuit 3 (step S2). As described above, the diode rectification control forms current paths as illustrated in FIG. 7. When the operating mode of the air conditioner 700 corresponds to a heating operation (step S1: No), the control unit 10 chooses to perform the synchronous rectification control with use of the switching elements 311, 312, 321, and 322 in the rectifier circuit 3 (step S3). As described above, the synchronous rectification control forms current paths as illustrated in FIG. 4.

The control unit 10 applies the current from the AC power supply 1 to the parasitic diodes 311a, 312a, 321a, and 322a of the rectifier circuit 3 or the switching elements 311, 312, 321, and 322 of the rectifier circuit 3 selectively according to the operating mode of the air conditioner 700. Specifically, when the operating mode of the air conditioner 700 is for a cooling operation, the control unit 10 applies the current from the AC power supply 1 to the parasitic diodes 311a, 312a, 321a, and 322a of the rectifier circuit 3. On the other hand, when the operating mode of the air conditioner 700 is for a heating operation, the control unit 10 applies the current from the AC power supply 1 to the switching elements 311, 312, 321, and 322 of the rectifier circuit 3. In this manner, the control unit 10 can select the diode rectification control during the cooling operation to obtain the advantageous effects of high efficiency operation and high reliability, and can select the synchronous rectification control during the heating operation to realize highly efficient operation. Note that the flowchart illustrated in FIG. 11 is based on the assumption that the air conditioner 700 has only two functions, that is, the cooling operation and the heating operation. In recent years, the air conditioner 700 has been designed to have multiple functions including dehumidification, air blowing operation, and the like, and so what function the conditioner has varies depending on the maker's product. Therefore, the method of control in the control unit 10 for obtaining the effects of the present embodiment is not necessarily limited to the example illustrated in FIG. 11.

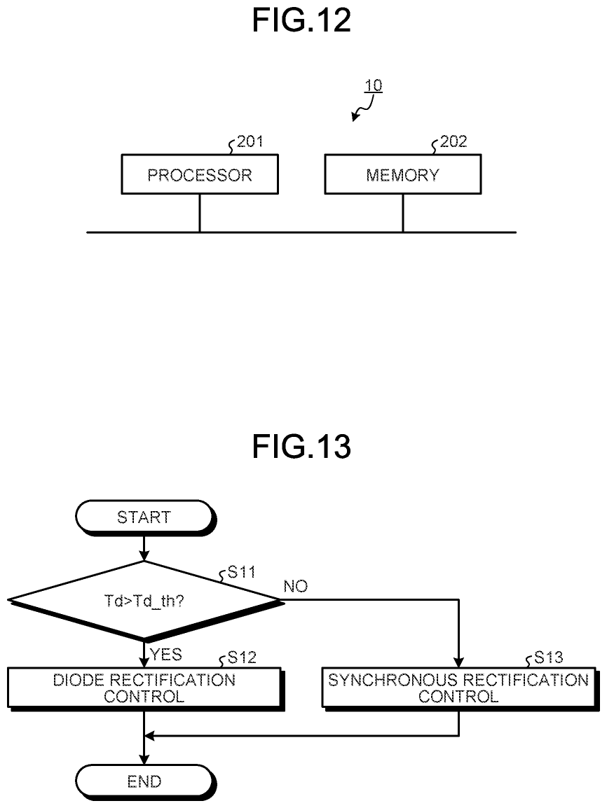

Next, a hardware configuration of the control unit 10 provided in the power conversion device 100 will be described. FIG. 12 is a diagram illustrating an exemplary hardware configuration for implementing the control unit 10 provided in the power conversion device 100 according to the first embodiment. The control unit 10 is implemented by the processor 201 and the memory 202.

The processor 201 is a CPU (also referred to as a central processing unit, a central processing device, a processing device, a computation device, a microprocessor, a microcomputer, a processor, or a digital signal processor (DSP)), or a system large scale integration (LSI) circuit. The memory 202 can be exemplified by a volatile or non-volatile semiconductor memory such as a random access memory (RAM), a read only memory (ROM), a flash memory, an erasable programmable read only memory (EPROM), or an electrically erasable programmable read only memory (EEPROM) (registered trademark). Alternatively, the memory 202 is not necessarily limited to these memory types, and may be a magnetic disk, an optical disk, a compact disk, a mini disk, or a digital versatile disc (DVD).

As described above, according to the present embodiment, the control unit 10 in the power conversion device 100 selects the diode rectification control in which rectification is performed by applying the current to the parasitic diodes 311a, 312a, 321a, and 322a in the rectifier circuit 3 during a cooling operation under high outside air temperature, and selects the synchronous rectification control in which rectification is performed by applying the current to the switching elements 311, 312, 321, and 322 that are MOSFETs in the rectifier circuit 3 during a heating operation under low outside air temperature. By so doing, the control unit 10 does not require an additional dedicated temperature sensor or the like, thereby preventing the device from upsizing, and can further achieve the effect of realizing highly efficient operation with simple control while preventing thermal runaway from occurring.

### Second Embodiment

In the second embodiment, description is given for a case where the control unit 10 of the power conversion device 100 uses a detection result from a temperature sensor beforehand provided in the air conditioner 700.

In the second embodiment, the configurations of the power conversion device 100 and the air conditioner 700 are substantially the same as those in the first embodiment illustrated in FIG. 1. In general, the air conditioner 700 is a device that is configured to utilize thermodynamics. Therefore, the air conditioner 700 includes at least one or more temperature sensors in each of the outdoor unit 703 and an indoor unit (not illustrated) in order to implement air-conditioning control. For example, in the case of the outdoor unit 703, a temperature sensor for detecting the discharge temperature is often set in the discharge pipe of the compressor. As described above, the substrate 701 installed in the outdoor unit 703 has high dependency on the ambient temperature. In particular, considering the installation position illustrated in FIG. 10, the ambient temperature further rises due to heat leakage from the compressor, heat transfer from the heat exchanger of the outdoor unit 703, and the like. In addition, since the outdoor unit 703 is set outdoors as the name indicates, the substrate 701 is often covered with sheet metal and/or the like, and so the substrate 701 is placed in a closed or sealed space. Furthermore, since the outdoor unit 703 itself also has sealability, the ambient temperature of the semiconductor elements such as the switching elements on the substrate 701 is linked to the temperatures of the compressor, the outdoor heat exchanger, and the like in addition to the normally considered outdoor air temperature. Therefore, the control unit 10 performs control to select the synchronous rectification control or the diode rectification control with utilizing a temperature sensor provided in the air conditioner 700.

FIG. 13 is a flowchart illustrating a control operation performed by the control unit 10 of the power conversion device 100 according to the second embodiment. In this example, the control unit 10 selects the diode rectification control or the synchronous rectification control according to the discharge temperature of the compressor, with use of a measurement result from a temperature sensor that detects the discharge temperature of the compressor. The control unit 10 compares a discharge temperature Td of the compressor measured with the temperature sensor with a prescribed temperature threshold Td_th (step S11). For example, in a case where the substrate 701 equipped with the power conversion device 100 is set in the outdoor unit 703 and the temperature of the substrate 701 and the discharge temperature of the compressor change in conjunction with each other, the temperature threshold Td_th is a discharge temperature of the compressor which corresponds to the temperature of the substrate 701 such that higher efficiency is achieved by applying the current to the parasitic diodes of the rectifier circuit 3 than by applying the current to the switching elements, in view of the temperature characteristics illustrated in FIGS. 8 and 9. The temperature threshold Td_th is obtained in advance through actual measurement or the like by the manufacturer of the air conditioner 700 or the like, and is preliminarily stored in the control unit 10 or a storage unit (not illustrated). When the discharge temperature Td of the compressor measured by the temperature sensor is higher than the temperature threshold Td_th (step S11: Yes), the control unit 10 chooses to perform the diode rectification control with use of the parasitic diodes 311a, 312a, 321a, and 322a in the rectifier circuit 3 (step S12). When the discharge temperature Td of the compressor measured by the temperature sensor is less than the temperature threshold Td_th (step S11: No), the control unit 10 chooses to perform the synchronous rectification control with use of the switching elements 311, 312, 321, and 322 in the rectifier circuit 3 (step S13).

The control unit 10 applies the current from the AC power supply 1 to the parasitic diodes 311a, 312a, 321a, and 322a of the rectifier circuit 3 or the switching elements 311, 312, 321, and 322 of the rectifier circuit 3 selectively according to the measurement result from the temperature sensor that measures the temperature in the refrigeration cycle of the air conditioner 700. In this manner, the control unit 10 can select the diode rectification control or the synchronous rectification control with high accuracy without an additional dedicated temperature sensor. Note that in this part, description is given for the case in which the control unit 10 uses the temperature sensor that measures the discharge temperature of the compressor, but this is one example and is not intended to limit the invention. The control unit 10 may use another temperature sensor installed in the air conditioner 700, e.g. a temperature sensor attached to an exterior heat exchanger.

In addition, the control unit 10 may parallelly use the control of the flowchart according to the second embodiment illustrated in FIG. 13 and the control of the flowchart according to the first embodiment illustrated in FIG. 11. For example, the control unit 10 may perform the control of the flowchart according to the second embodiment illustrated in FIG. 13 in the case of either Yes in step S1 or No in step S1 in the flowchart illustrated in FIG. 11.

As described above, according to the present embodiment, the control unit 10 in the power conversion device 100 selects the diode rectification control in which the current is applied to the parasitic diodes 311a, 312a, 321a, and 322a in the rectifier circuit 3 or the synchronous rectification control in which the current is applied to the switching elements 311, 312, 321, and 322 that are MOSFETs in the rectifier circuit 3, using a measurement result of a temperature sensor beforehand set in the air conditioner 700. By doing so, the control unit 10 does not require any additional dedicated temperature sensor or the like, and therefore an advantageous effect is exerted whereby the device is prevented from upsizing, and highly efficient operation can be realized with simpler control and with higher accuracy while thermal runaway is prevented from occurring.

### Third Embodiment

The third embodiment describes a motor drive apparatus including the power conversion device 100 described in the first and second embodiments.

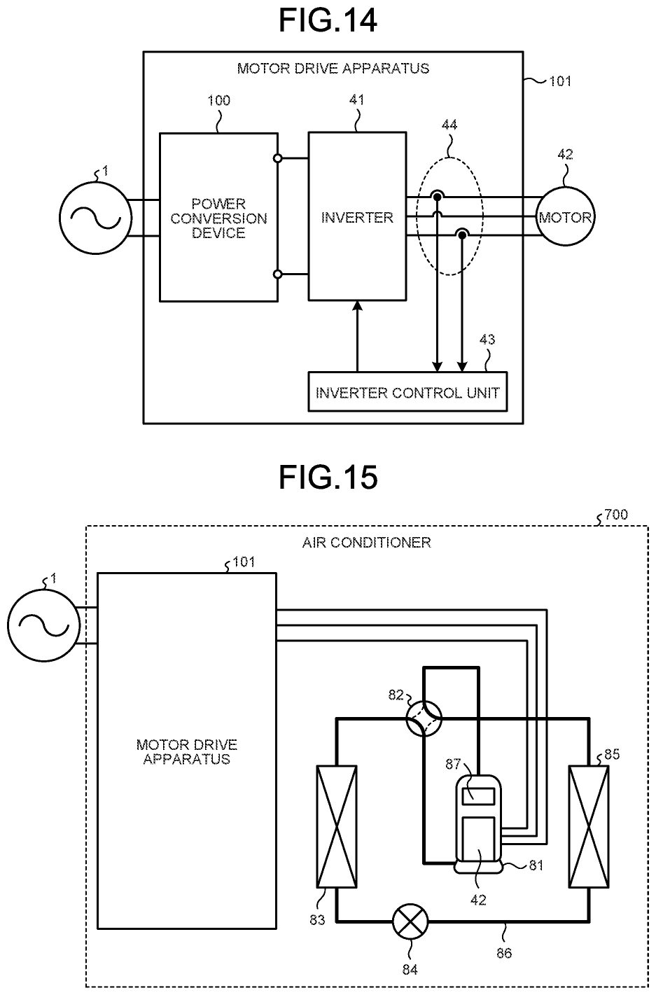

FIG. 14 is a diagram illustrating an exemplary configuration of a motor drive apparatus 101 according to the third embodiment. The motor drive apparatus 101 drives a motor 42 that serves as a load. The motor drive apparatus 101 includes the power conversion device 100 according to the first or second embodiment, an inverter 41, a motor current detection unit 44, and an inverter control unit 43. The inverter 41 drives the motor 42 by converting DC power supplied from the power conversion device 100 into AC power and outputting the AC power to the motor 42. In this example, the load for the motor drive apparatus 101 is the motor 42. However, instead of the motor 42, any device to which AC power is inputted may be connected to the inverter 41.

The inverter 41 is a circuit in which switching elements such as insulated gate bipolar transistors (IGBTs) have a three-phase bridge configuration or a two-phase bridge configuration. Instead of IGBTs, switching elements formed of WBG semiconductors, integrated gate commutated thyristors (IGCTs), field-effect transistors (FETs), or MOSFETs may be used as the switching elements used for the inverter 41.

The motor current detection unit 44 detects an electric current flowing between the inverter 41 and the motor 42. The inverter control unit 43 uses the current detected by the motor current detection unit 44 to generate PWM signals for driving the switching elements in the inverter 41 and apply the PWM signals to the inverter 41 so that the motor 42 rotates at a desired rotational speed. In basically the same manner as the control unit 10, the inverter control unit 43 is implemented by use of a processor and a memory. Note that the inverter control unit 43 of the motor drive apparatus 101 and the control unit 10 of the power conversion device 100 may be implemented by a single circuit.

In a case where the power conversion device 100 is used for the motor drive apparatus 101, the bus voltage Vdc necessary for control on the rectifier circuit 3 changes in accordance with the operating state of the motor 42. In general, an output voltage of the inverter 41 is required to be higher as the rotational speed of the motor 42 increases. The upper limit of the output voltage from the inverter 41 is restricted by the input voltage to the inverter 41, that is, the bus voltage Vdc that is an output of the power conversion device 100. A region in which the output voltage from the inverter 41 is saturated above the upper limit restricted by the bus voltage Vdc is referred to as an overmodulation region.

In this motor drive apparatus 101, it is not necessary to boost the bus voltage Vdc in a low revolution range of the motor 42, that is, in a range below the overmodulation region. On the other hand, when the motor 42 rotates in high revolution, the overmodulation region can be shifted to a higher revolution side by boosting the bus voltage Vdc. Consequently, the operating range of the motor 42 can be expanded to the high revolution side.

If it is not necessary to expand the operating range of the motor 42, the number of turns of a winding for a stator of the motor 42 can be increased accordingly. The increase in the number of turns of the winding leads to an increase in motor voltage generated between two ends of the winding in the low revolution region, and accordingly to a reduction in the current flowing through the winding, thereby making it possible to reduce the loss caused by the switching operation of the switching elements in the inverter 41. In order to obtain the effects of both the expansion of the operating range of the motor 42 and the loss improvement in the low revolution region, the number of turns of the winding of the motor 42 is set to an appropriate value.

As described above, according to the present embodiment, by virtue of use of the power conversion device 100, the highly reliable and high-powered motor drive apparatus 101 can be achieved with the unevenness of heat generation between the arms being reduced.

### Fourth Embodiment

The fourth embodiment describes an air conditioner including the motor drive apparatus 101 described in the third embodiment.

FIG. 15 is a diagram illustrating an exemplary configuration of the air conditioner 700 according to the fourth embodiment. The air conditioner 700 is an example of a refrigeration cycle apparatus, and includes the motor drive apparatus 101 and the motor 42 according to the third embodiment. The air conditioner 700 includes a compressor 81 incorporating a compression mechanism 87 and the motor 42, a four-way valve 82, an outdoor heat exchanger 83, an expansion valve 84, an indoor heat exchanger 85, and a refrigerant pipe 86. The air conditioner 700 is not limited to a separate type air conditioner in which the outdoor unit 703 is separated from the indoor unit, and may be an integrated type air conditioner in which the compressor 81, the indoor heat exchanger 85, and the outdoor heat exchanger 83 are provided in one housing. The motor 42 is driven by the motor drive apparatus 101.

Inside the compressor 81, the compression mechanism 87 configured to compress a refrigerant and the motor 42 set to operate the compression mechanism 87 are provided. The refrigerant circulates through the compressor 81, the four-way valve 82, the outdoor heat exchanger 83, the expansion valve 84, the indoor heat exchanger 85, and the refrigerant pipe 86, thereby forming a refrigeration cycle. Note that the components of the air conditioner 700 are also applicable to devices such as refrigerators or freezers which have a refrigeration cycle.

In the exemplary configuration described in the present embodiment, the motor 42 is used as a drive source for the compressor 81, and the motor 42 is driven by the motor drive apparatus 101. However, the motor 42 may be applied to a drive source for driving an indoor unit blower and an outdoor unit blower (not illustrated) provided in the air conditioner 700, and the motor 42 may be driven by the motor drive apparatus 101. Alternatively, the motor 42 may be applied to a drive source for the indoor unit blower, the outdoor unit blower, or the compressor 81, and the motor 42 may be driven by the motor drive apparatus 101.

Over the course of a year, the air conditioner 700 operates dominantly under intermediate conditions in which the output is equal to or less than half the rated output, that is, under low-output conditions. Therefore, the contribution to the annual power consumption under the intermediate conditions is high. Additionally, the rotational speed of the motor 42 of the air conditioner 700 is low, and so the bus voltage Vdc required to drive the motor 42 tends to be low. For this reason, it is effective to operate the switching elements used for the air conditioner 700 in a passive state from the viewpoint of system efficiency. Therefore, the power conversion device 100 capable of reducing loss in a wide range of operating modes from the passive state to the high-frequency switching state is useful for the air conditioner 700. As described above, in an interleave system, the reactor 2 can be reduced in size, but the air conditioner 700 relatively frequently operates under the intermediate conditions, thus leading to a low degree of need to reduce the size of the reactor 2, and the configuration and operation of the power conversion device 100 is more effective in terms of harmonic suppression and the power factor of the power supply.

In addition, since the power conversion device 100 can reduce the switching loss, the rise in temperature of the power conversion device 100 is suppressed, and a capacity of cooling the substrate 701 equipped in the power conversion device 100 can be reserved even if the size of the outdoor unit blower (not illustrated) is made smaller. Therefore, the power conversion device 100 is suitable for the air conditioner 700 that is highly efficient and achieves a high output of 4.0 kW or more.

According to the present embodiment, since the unevenness of heat generation between the arms is reduced by using the power conversion device 100, the reactor 2 can be reduced in size as a result of the high-frequency driving of the switching elements, and an increase in weight of the air conditioner 700 can be prevented. According to the present embodiment, the switching loss is reduced as a result of the high frequency driving of the switching elements, and so the highly efficient air conditioner 700 with a low energy consumption rate can be achieved.

The configurations described in the above-mentioned embodiments illustrate examples of the contents of the present invention, and can each be combined with other publicly known techniques and partially omitted and/or modified without departing from the scope of the present invention.

1. An air conditioner including a power conversion device, the power conversion device comprising:
a reactor having a first end and a second end, the first end being connected to an AC power supply;
a rectifier circuit that is connected to the second end of the reactor and includes a diode and at least one or more switching elements, the rectifier circuit converting an AC voltage outputted from the AC power supply into a DC voltage; and
a detection unit detecting a physical quantity indicating an operation state of the rectifier circuit,
wherein the air conditioner makes switching between control for a current from the AC power supply to be applied to the diode and control for the current to be applied to the switching element in accordance with an operating mode of the air conditioner, and
when the operating mode of the air conditioner corresponds to a cooling operation, the current from the AC power supply is applied to the diode.

2. (canceled)

3. An air conditioner including a power conversion device, the power conversion device comprising:
a reactor having a first end and a second end, the first end being connected to an AC power supply;
a rectifier circuit that is connected to the second end of the reactor and includes a diode and at least one or more switching elements, the rectifier circuit converting an AC voltage outputted from the AC power supply into a DC voltage; and
a detection unit detecting a physical quantity indicating an operation state of the rectifier circuit,
wherein the air conditioner makes switching between control for a current from the AC power supply to be applied to the diode and control for the current to be applied to the switching element in accordance with an operating mode of the air conditioner, and
when the operating mode of the air conditioner corresponds to a heating operation, the current from the AC power supply is applied to the switching element.

4. An air conditioner including a power conversion device, the power conversion device comprising:
a reactor having a first end and a second end, the first end being connected to an AC power supply;
a rectifier circuit that is connected to the second end of the reactor and includes a diode and at least one or more switching elements, the rectifier circuit converting an AC voltage outputted from the AC power supply into a DC voltage; and
a detection unit detecting a physical quantity indicating an operation state of the rectifier circuit,
wherein the air conditioner makes switching between control for a current from the AC power supply to be applied to the diode and control for the current to be applied to the switching element in accordance with an operating mode of the air conditioner, and
the switching is made between control for the current from the AC power supply to be applied to the diode or control for the current from the AC power supply to be applied to the switching element according to a measurement result of a temperature sensor that measures a temperature in a refrigeration cycle of the air conditioner.

5. The air conditioner according to claim 1, wherein the power conversion device is installed in an outdoor unit of the air conditioner.

6. The air conditioner according to claim 3, wherein the power conversion device is installed in an outdoor unit of the air conditioner.

7. The air conditioner according to claim 4, wherein the power conversion device is installed in an outdoor unit of the air conditioner.
